(19) United States
(12) Patent Application Publication
(10) Pub. No.: US 2022/0252358 A1
(43) Pub. Date: Aug. 11, 2022

(54) HORIZONTAL NOZZLE HEAT AND MASS EXCHANGER

(71) Applicants: Vitaliy Alekseevich Uzikov, Dimitrovgrad (RU); Land Green & Technology Co., Ltd, Taipei City (TW)

(72) Inventors: Vitaliy Alekseevich Uzikov, Dimitrovgrad (RU); Irina Vitalevna Uzikova, Dimitrovgrad (RU); Sergey Vladimirovich Rogozhkin, Dimitrovgrad (RU)

(21) Appl. No.: 17/650,102

(22) Filed: Feb. 7, 2022

(30) Foreign Application Priority Data
Feb. 7, 2021 (RU) 2021102790

(51) Int. Cl. F28D 21/00; F28F 5/02

(52) U.S. Cl. CPC F28D 21/0015; F28F 5/02

(57) ABSTRACT

Provided is a horizontal packed heat and mass transfer apparatus containing a cylindrical body partially filled with liquid with bottoms and at least one split flange, branch pipes of a gas medium in the upper part of the apparatus and a liquid medium in the lower part, a rotation shaft mounted on bearing supports in housing bottoms, with a rotation drive, a set of sections of annular packing structures rigidly connected to the shaft, located adjacent along the axis of the shaft, separated by external annular and internal annular, forming a zigzag radial-axial and series-parallel channel for gas passage through adjacent annular packing structures, the space between which is filled with nozzle elements, wherein the annular nozzle structures are partially immersed in the liquid, and the liquid filling level in the body and the rotation frequency of the nozzle structures are provided.

### CROSS-REFERENCE TO RELATED APPLICATION

This application claims the benefit of and priority to Russian Patent Application No. 2021102790 filed on Feb. 7, 2021, which is herein incorporated by reference in its entirety.

### TECHNICAL FIELD

This invention relates to chemical engineering. Specifically, this invention relates to processes and devices for chemical engineering and can be used in power, oil and gas, nuclear, chemical, food, pharmacological and other industries for rectification, absorption, vacuum evaporation, desorption, concentration, etc. processes in the gas-liquid system, as well as in absorption systems aimed at preventing the release of hydrocarbon vapors into the atmosphere at oil refineries, for purifying steam from radioactive aerosols during the concentration of liquid radioactive waste by evaporation, etc. A horizontal packed heat and mass transfer apparatus containing a cylindrical body partially filled with liquid with bottoms and at least one split flange, nozzles for a gas (vapor) medium in the upper part of the apparatus and a liquid medium in the lower part. The apparatus has a set of sections of annular packing structures, partially immersed in a liquid and located adjacent along the axis of the shaft, separated by external annular and internal annular or disk partitions, which form a zigzag radial-axial and series-parallel channel for the passage of gas or steam through adjacent annular packing structures.

This invention allows simplifying the design of the apparatus, providing a higher manufacturability, achieving a higher efficiency of heat and mass transfer processes, increasing the productivity of the apparatus, using the kinetic energy of the gas or steam entering the apparatus as a driving force to drive the rotation of the packing structures.

### TECHNICAL BACKGROUND

A device is widely known from the prior art for carrying out a heat and mass transfer process by contacting a gas stream with a liquid stream flowing on the surface of droplets or a liquid film in packed film columns. Packed mass transfer apparatuses are columns filled with packing—geometric bodies with the most developed surface (rings, saddles, lumpy material, etc.). The contact of a gas (vapor) with a liquid occurs on the wetted surface of the packing, over which the absorbing liquid flows. The flow of liquid through the packing is mainly of a film nature, and therefore the packing devices are of the film type (see I. T. Balyberdina, Physical methods of gas processing and use: Textbook for universities.—M.: Nedra, 1988, p. 56.)

In this case, the intensity of heat and mass transfer is determined by the velocities of the gas and liquid flows and largely depends on the size and shape of the contacting surface, the volumetric homogeneity of the process. However, an increase in the intensity of heat and mass transfer leads to an increase in gas-dynamic resistance (sometimes local), entrainment of liquid droplets, which leads to a complication of the design and an increase in the dimensions of heat and mass transfer apparatus. In addition, the inhomogeneity of the flow of processes in the volume of the packings (bypass effects, etc.) required the introduction of design solutions to equalize the distribution and interaction of flows in the gas-liquid system (transition to regular packings, etc.). This led to an increase in the specific surface area of the nozzles and to an increase in their height.

Close to the invention is a device for carrying out heat and mass transfer processes by contacting a gas stream with a liquid stream flowing down in the form of a film over the surface of rotating discs partially submerged in liquid (see patent RU 2321444 C2). The heat and mass transfer apparatus is made in the form of a cylindrical (horizontal) body with flanges, in which there are nozzles for supplying and discharging gas and nozzles for supplying and discharging liquid in a counterflow mode. The apparatus is equipped with a rotating shaft with successively alternating dividing annular partitions installed on it, around which a shell is installed with a gap relative to the cylindrical body, rigidly connected to the dividing annular partitions, jointly forming sections. In the sections on the shaft there are transverse solid disks, between which there are annular contact disks with a gap relative to the housing, shaft and each other. All disks are rigidly fastened to each other by longitudinal pins fixed in the extreme dividing annular partitions. The shaft is made of two axle shafts. A hole is made in the semi-axis from the gas outlet side, connecting the first section from the side of this semi-axis with the gas outlet pipe installed on the flange of the apparatus. A fluid supply pipe is installed inside the hollow shaft and coaxially to it. Holes are made in the extreme dividing annular partition on the side of the liquid outlet, while the heat and mass transfer apparatus is installed with an inclination of 2 to 10 degrees towards the liquid outlet branch pipe. All discs and shell are partially immersed in liquid and, when rotating, together form a zigzag, rotary, radial-axial, series-parallel countercurrent flow of gas and liquid flows. The advantage of this device is low hydraulic resistance along the working path, uniformity and stability of heat and mass transfer processes, high productivity and small dimensions. The main problem of this device is the complexity of the disk design, as well as the supply of liquid and gas removal in it.

Known heat and mass transfer apparatus (see patent RU 2200054 C1) containing a rotating shaft and a cylindrical body, in the upper part of which are installed pipes for supplying and discharging gas, and at the bottom—pipes for supplying and discharging liquid, equipped with a set of dividing annular partitions, between the extreme partitions of the set, cylindrical inserts are installed, between which the rest of the partitions of the set are placed, and the inserts and partitions are fastened together, and one of the extreme partitions is fastened to the body. The baffle inserts form sections in which transverse solid discs are mounted on the rotating shaft, on the sides of which are fixed packs of annular contact discs installed with a gap relative to the inserts, the shaft, each other and dividing annular baffles and partially immersed in the liquid, and which together form a zigzag, radial-axial, series-parallel flow of gas streams. The main disadvantage of this device is the difficulty of providing small gaps in the packets between thin annular discs of large diameter, which significantly limits the area of contact between liquid and gas per unit volume.

The closest to the proposed invention should be attributed to the apparatus with a rotating bed of packing (RU 2548081 C1), in which a significant increase in the area of the contact surface is achieved in comparison with disk heat-mass transfer apparatus. Rotating packing layers located on the shaft adjacent to each other and separating annular partitions form a zigzag, radial-axial flow of gas flows through the wetted packing layers. The advantage of this apparatus is that the combination of layers allows the use of different types of nozzles, as well as different relative sizes of the nozzles, including radial, cross-sectional areas. In addition, this device allows different mass ratios of liquid and gas flows through two packing beds and allows the use of the same or different fluids for different beds.

However, when the liquid is radially sprayed from the holes in the rotating shaft, an increased drop-aerosol entrainment will be observed at the outlet of the gas flow from the apparatus. In addition, to ensure a uniform irrigation density and full wettability of the surface of the nozzles, it is necessary to maintain a certain value of the liquid flow rate during irrigation. Sealing the fluid inlet and outlet through a rotating shaft also poses a number of problems.

All the devices described above with rotating wetted surfaces for heat and mass transfer (annular contact discs and annular nozzles) require an external drive for shaft rotation.

According to an embodiment of the present invention, a horizontal packed heat and mass transfer apparatus is presented which contains a cylindrical body partially filled with liquid with bottoms and at least one split flange, branch pipes of a gas medium in the upper part of the apparatus and a liquid medium in the lower part, a rotation shaft mounted on bearing supports in housing bottoms, with a rotation drive, a set of sections of annular packing structures rigidly connected to the shaft, located adjacent along the axis of the shaft, separated by external annular and internal annular or disk partitions, forming a zigzag radial-axial and series-parallel channel for gas passage through adjacent annular packing structures, made of external and internal coaxial perforated shells, the space between which is filled with nozzle elements, characterized in that the annular nozzle structures are partially immersed in the liquid, and the liquid filling level in the body and the rotation frequency of the nozzle structures are provided.

The drive for rotation of the set of sections of annular packed structures is made in the form of a turbine-type pneumatic engine, in which the role of blades is played by the ribs on the end surface of the set of sections facing the stream with a wide surface the gas entering the apparatus, and the gas medium is supplied through a branch pipe on the body located tangentially to the generatrix of the trajectory of rotation of the ribs.

The branch pipe for supplying the gas medium to the housing is equipped with an adjustable restriction device.

The packed annular structure is made of coaxial perforated shells of different diameters, the space between which is filled with nozzles.

The design of the seal assembly of the outer annular baffle ensures the absence or minimal leakage of gas (vapor) between the annular packed structure and the casing.

The design of the seal assembly of the outer annular baffle provides fluid flow between the sections below the liquid level.

The design of the seal unit of the outer annular partition ensures the absence or minimum flow of liquid between the sections in the casing, and the sections in the lower part of the casing can be equipped with nozzles for supply and discharge of liquid.

At least one of the sections is equipped with a liquid heating element, and there is no vapor medium supply pipe.

One or more sections are provided with an element for cooling the liquid.

### BRIEF DESCRIPTION OF DRAWINGS

The following description refers to the accompanying drawings, which show, by way of non-limiting example, an embodiment of the invention in which:

FIG. 1 is a diagram of a longitudinal section of a horizontal packed heat and mass transfer apparatus (HNTMOA), made in accordance with the invention;

FIG. 2 is a diagram of the structure of the unit for sealing the external annular partition with a fluid flow;

FIG. 3 is a diagram of the structure of the sealing unit of the outer annular partition without a liquid flow;

FIG. 4 is a diagram of a longitudinal section of a GNTMOA with a rotation drive in the form of a pneumatic turbine engine and a diagram of a cross-section in the section of a gas supply made in accordance with the invention;

FIG. 5 is a diagram of a longitudinal section of a GNTMOA, made in accordance with the invention, designed to purify radioactive water from tritium isotopes.

### DETAILED DESCRIPTION

The invention is directed to the creation of compact and efficient horizontal heat and mass transfer apparatus with a rotating nozzle, minimal energy consumption, technologically advanced in manufacture and operation, providing minimal drip-aerosol entrainment and full wettability of the surface of the nozzles at any liquid flow rate.

The solution to this problem is achieved by the fact that in a horizontal packed heat and mass transfer apparatus (GNTMOA), containing a cylindrical body with bottoms, and at least one split flange, inlet and outlet pipes of working media (liquid, gas or steam), a rotation shaft, mounted on bearings with seals in the bottom of the housing, a set of separating annular or disk partitions forming sections with annular nozzle structures rigidly connected by a shaft, which form a zigzag, radial-axial, series-parallel flow of gas streams, while, according to the invention, each of packing structures is partially immersed in liquid, coaxial to the rotation shaft and is made of external and internal coaxial perforated shells of different diameters, the space between which is filled with packing elements.

The flow path between the packed structures is formed by rotating internal annular or disc baffles, as well as external annular baffles. The design of the sealing unit of the annular partition should ensure the absence or minimal bypassing of the packing structure in the gas cavity by gas (steam). This is achieved by the presence of sealing elements in the form of elastic or elastic rings along the outer diameter of the annular partitions, blocking the free passage of gas (vapor) between the rotating annular partition and the surface of the sealing structure inside the apparatus body.

This design can be made, for example, in the form of an axially movable but not rotating annular sleeve tightly adhering to the inner surface of the cylindrical body; an annular groove is made inside the sleeve, mating with the outer surface of the annular partition through a sealing element. In the lower part of the annular sleeve, channels are made for free passage of liquid from each section to the adjacent section, providing fluid replacement in the sections. In this case, to replace the liquid in the device, two nozzles are enough for the inlet and outlet of the liquid.

Another option for replacing the liquid in the sections is the complete absence of channels in the annular sleeve for free passage of liquid from each section to the adjacent section, thereby ensuring relative liquid tightness between the sections, but at the same time, each section is equipped in the lower part of the apparatus with liquid inlet and outlet pipes . . . . In this case, the possibility of using liquids of different composition in different sections is provided, which makes it possible to significantly expand the possibilities of carrying out heat and mass transfer processes in the apparatus.

The design of GNTMOA allows using the kinetic energy of the gas flow entering the apparatus to drive the shaft with packing structures into rotation. In this case, the drive for rotation of the packing structures can be made in the form of a turbine-type pneumatic engine, in which the role of blades is played by radial ribs on the end surface of a set of sections of annular packing structures, and the gas (vapor) medium is supplied to the apparatus body tangentially generating the trajectory of rotation of the ribs. The speed of rotation of a set of sections of annular packing structures is determined by the hydraulic resistance of the liquid in the lower part and the torque on the blades when they are exposed to the gas flow entering the GNTMOA. To increase the kinetic energy of the gas flow, a restriction device can be installed at the tangential inlet, which will lead to an increase in the gas flow rate and an increase in torque on the radial ribs. The degree of reduction of the flow area in the restriction device can be adjustable, which will allow changing the gas flow rate at the inlet to the GMNMOA, and, accordingly, the torque on the blades and the rotational speed of a set of sections of annular packing structures.

The design of GNTMOA allows it to be used for tritium removal from water. The possibility of using such an apparatus for isotopic separation of water based on the presence of tritium in the molecule is based on the fact that at deep discharge (600-700 Pa) and low water temperature near the triple point (just above 1° C.), molecules with tritium become inactive and are deposited on wet surfaces of nozzles. This is due to the fact that the freezing point of tritium water is T₂O is +9.0° C., and for HTO molecules the freezing temperature is +4.5° C. In this case, the apparatus must be equipped with a water heater providing steam generation, a steam outlet pipe, while there is no steam inlet pipe to the GNTMOA.

If the interaction of gas streams and a liquid film on the packing occurs with the release of heat (exothermic reaction), in order to ensure the required temperature regimes, the sections in the lower part can be equipped with tubular heat exchangers with coolers that remove excess heat from the liquid.

The stated complex of design solutions allows you to achieve the goals and provides:

A. high values of the heat and mass transfer surface of the GNTMOA with low hydraulic resistance;
B. high performance in the gaseous environment;
C. compactness, simplicity and manufacturability of GNTMOA design;
D. low energy consumption during the operation of the apparatus;
E. full wettability of the entire surface of the nozzles, periodically immersed in the liquid;
F. minimal drip-aerosol entrainment;
G. the possibility of using the kinetic energy of the gas flow entering the GNTMOA as a driving force for a turbine-type rotation drive;
H. the possibility of ensuring complete tightness with the environment of the bearing support of the GNTMOA shaft from the side of the rotation drive when using a turbine-type pneumatic motor as a rotation drive.

A significant increase in the efficiency of horizontal heat and mass transfer devices with a rotating nozzle in comparison with similar disk devices is achieved by a multiple increase in the specific surface of the nozzles (for example, for SPN 4×4×0.2 it is 2700 m²/m³) and its disordered arrangement (in contrast to slotted channels with disk nozzles), which sharply reduces the height of the theoretical separation stage (HETS) to 2.4 cm, which characterizes the efficiency of mass transfer. An increase in the efficiency of heat and mass transfer in comparison with the apparatus with a rotating bed of the packing according to the patent RU 2548081 C1 is achieved by the fact that the proposed design ensures full wettability of the packing at any, even the most structures periodic immersion in the liquid of all nozzles, up to those adjacent to the inner perforated shell.

The minimum energy consumption is achieved in the absence of the need to spray liquid under pressure from the shaft side, as is done, for example, in patent RU 2548081 C1. The minimum droplet-aerosol entrainment is achieved by the ability to provide a low gas flow rate with a large flow area in the nozzle structures, as well as by the design of the nozzles itself, which traps small drops and sols on their wetted surface.

With an increase in the rotation speed of the packing structures and the liquid flow rate, the intensity of mass transfer between the liquid and the gas increases, and due to the low porosity of the packing structures and the rapid drainage of the liquid from the packing structures after their periodic immersion, the absence of a flooding mode at high gas flows is ensured, as is packed columns. Taking into account the developed contact surface, the productivity of such devices is significantly higher than in the disk packaged devices with comparable overall dimensions.

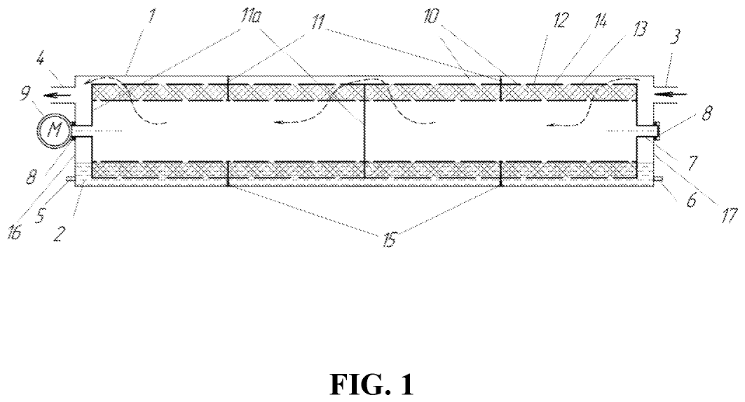

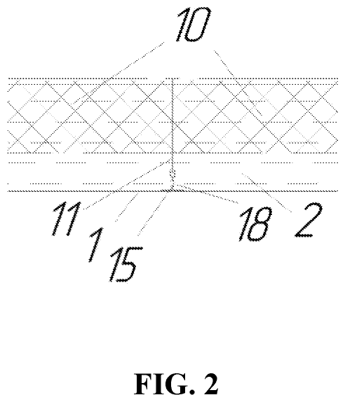

FIG. 1 schematically shows a longitudinal section of the GNMOA, including a cylindrical body (1) with bottoms (16) and (17) partially filled with liquid (2), branch pipes for supplying and removing a gas medium (3) and (4), supply and outlet pipes liquids (5) and (6), a shaft (7) on bearing supports (8) with a rotation drive (9), a set of separating annular (11) or disc baffles (11a), forming sections, annular packing structures rigidly connected to the shaft (10), which together with the partitions (11 and 11a) form a zigzag, radial-axial, series-parallel flow of gas flows. Annular packing structures are made of external (12) and internal (13) coaxial perforated shells of different diameters, the space between which is filled with packing elements (14). The design of the sealing unit (15) of the outer annular partition (11) ensures the absence or minimal gas bypassing of the packing structures in the gas cavity, and at the same time, for the given variant, provides a free flow of liquid through the hole (FIG. 2, pos. 18) in the lower parts of the sealing unit (FIG. 2, pos. 15) under the water level.

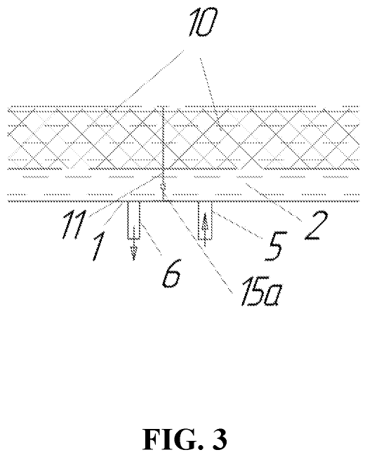

Another embodiment of the invention may be a separate supply and discharge of fluids to different sectors, and the fluids may have a different composition for different sectors. In this case, the sealing units (FIG. 3, pos. 15a) of the outer annular partitions (11) ensure the absence or minimal fluid leaks between the flooded sectors of the sectors, and in the sectors themselves, in the lower part of the body, the supply (FIG. 3, pos. 0.5) and outlet (FIG. 3, pos. 6) nozzles for fluid replacement.

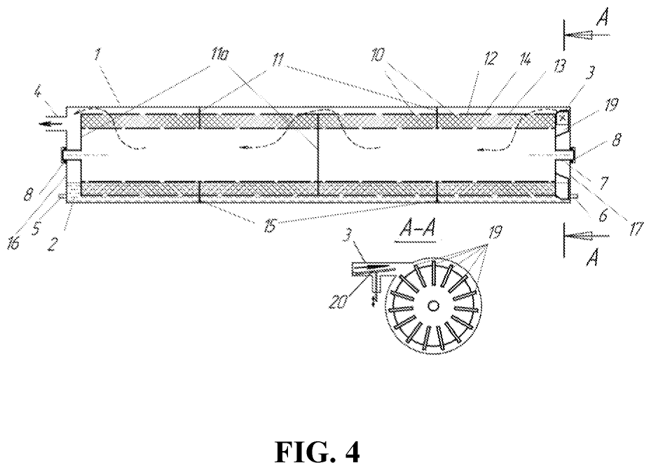

FIG. 4 schematically shows the longitudinal and transverse sections of the GNTMOA for the case if the rotation drive is made in the form of a turbine-type pneumatic engine, in which the role of blades is played by radial ribs (19) on the end surface of a set of sections of annular packing structures, and the gas (steam) supply of the medium into the body of the apparatus is made through the branch pipe (3), which is located tangentially to the generatrix of the trajectory of rotation of the ribs (19). To increase the kinetic energy of the gas flow, an adjustable restriction device (20) can be installed at the tangential inlet pipe (3), which makes it possible to change the magnitude of the torque on the radial ribs (19) and, accordingly, the rotational speed.

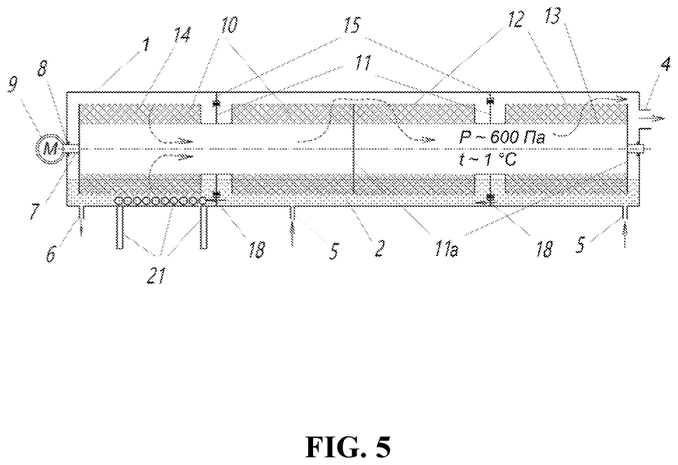

FIG. 5 schematically shows a longitudinal section of the GNMOA, including a cylindrical body (1) partially filled with liquid (2), a steam outlet pipe (4), purified water inlet pipes (5) and a tritium-enriched water outlet pipe (6), a shaft (7) on bearing supports (8) with a rotation drive (9), a set of separating annular (11) or disk partitions (11a), forming sections rigidly connected to the shaft, annular packing structures (10), which are formed together with partitions (11 and 11a) zigzag, radial-axial, series-parallel flow of the steam to be purified, as well as a tubular heat exchanger-heater (21), which compensates for heat loss during evaporation.

The water heating system in this apparatus (1) to compensate for heat entrainment with steam is provided by a heat exchanger-heater (21) with heating pipes located in the section opposite to the steam outlet. Steam contaminated with tritium, repeatedly passing through the evaporation-condensation stage on the wetted surface of the packing, is cleaned of water molecules containing tritium. The concentrate enriched with tritium is discharged into the storage tank through the branch pipe (6), and the water vapor purified from tritium is discharged through the branch pipe (4).

An example of a specific execution.

As a non-limiting example of a specific implementation, a horizontal packed heat-mass transfer apparatus for cleaning steam from aerosols during evaporation of liquid radioactive waste is considered.

As an example of a specific implementation, a 4-section GNMOA apparatus with a body diameter of 1.2 m, a length of 4.5 m and a pressure of 1.1 atm is considered, used to purify steam from radioactive aerosols (FIG. 1). Steam productivity 3.2 t/h (4850 m³ h). The lower limit for reflux consumption is not regulated and is set from the condition of achieving the required degree of steam purification from radionuclides. As a packing, an irregular spiral prismatic packing of Selivanenko (SPN 4×4×0.2) is used. The specific load on the nozzles during the passage of steam is ˜1200 kg/m² h. The length of each section of the nozzles is 1 m, the diameter of the outer perforated shell is 1.0 m, and the diameter of the inner perforated shell is 0.7 m. The thickness of the annular layer of the packing of the nozzles is 0.15 m. The loss of pressure on the shells and nozzles at a given productivity for steam is 0.22 kPa at each section [Sakharovsky Yu. A. Mass Transfer and Fluid Dynamics in Columns with High-Efficiency Packing: A Tutorial. M.: RKhTU im. DI. Mendeleev. 2010. 68 s.]. When the steam flow through the packed structures in 4 sections along the zigzag channel, the steam pressure loss will be ˜1.3 kPa.

The limiting specific throughput for packings of the selected type at a pressure of 1.1 atm is 3600 kg/(m²h) [Belkin D. Yu., Isotope purification of the coolant of an industrial heavy-water reactor LF-2/Dissertation, M.: RKhTU im. DI. Mendeleev, 2016], which is 3 times more than in the apparatus under consideration. Thus, the GNTMOA apparatus with the declared parameters operates in a gentle mode, which ensures a high degree of steam purification.

In addition, the degree of steam purification from radioactive elements can be easily adjusted based on the readings of dosimetric instruments that monitor the activity of condensate after steam condensation. The degree of purification is controlled by changing the reflux flow rate and the rotational speed of the packing structures. With their increase, the intensification of the absorption of radioactive aerosols on the films of the nozzles in the sectors from the side of the steam inlet occurs, which makes it possible to increase the degree of steam purification at the outlet of the apparatus.

In the case of using a turbine-type rotary drive (FIG. 4), the steam velocity in a narrow section of the inlet nozzle orifice is about 80 m/s (at Dy140 mm), therefore calculations have shown that the kinetic energy of the supplied steam is sufficient for the rotation frequency of the nozzles, taking into account the hydraulic resistance of water in the lower flooded part, it was about 12 rpm. If the rotation frequency of the nozzles is insufficient to ensure the required intensity of mass transfer, and, accordingly, to ensure the required parameters for cleaning steam from radioactive aerosols, the required shaft rotation speed can be provided using an electric drive.

What is claimed is:

1. A horizontal packed heat and mass transfer apparatus containing a cylindrical body partially filled with liquid with bottoms and at least one split flange, branch pipes of a gas medium in the upper part of the apparatus and a liquid medium in the lower part, a rotation shaft mounted on bearing supports in housing bottoms, with a rotation drive, a set of sections of annular packing structures rigidly connected to the shaft, located adjacent along the axis of the shaft, separated by external annular and internal annular or disk partitions, forming a zigzag radial-axial and series-parallel channel for gas passage through adjacent annular packing structures, made of external and internal coaxial perforated shells, the space between which is filled with nozzle elements, characterized in that the annular nozzle structures are partially immersed in the liquid, and the liquid filling level in the body and the rotation frequency of the nozzle structures are provided.

2. The horizontal packed heat and mass transfer apparatus according to claim 1, characterized in that the drive for rotation of the set of sections of annular packed structures is made in the form of a turbine-type pneumatic engine, in which the role of blades is played by the ribs on the end surface of the set of sections facing the stream with a wide surface the gas entering the apparatus, and the gas medium is supplied through a branch pipe on the body located tangentially to the generatrix of the trajectory of rotation of the ribs.

3. The horizontal packed heat and mass transfer apparatus according to claim 2, characterized in that the branch pipe for supplying the gas medium to the housing is equipped with an adjustable restriction device.

4. The horizontal packed heat and mass transfer apparatus according to claim 1, characterized in that the packed annular structure is made of coaxial perforated shells of different diameters, the space between which is filled with nozzles.

5. The horizontal packed heat and mass transfer apparatus according to claim 1, characterized in that the design of the seal assembly of the outer annular baffle ensures the absence or minimal leakage of gas (vapor) between the annular packed structure and the casing.

6. The horizontal packed heat and mass transfer apparatus according to claim 1, characterized in that the design of the seal assembly of the outer annular baffle provides fluid flow between the sections below the liquid level.

7. The horizontal packed heat and mass transfer apparatus according to claim 1, characterized in that the design of the seal unit of the outer annular partition ensures the absence or minimum flow of liquid between the sections in the casing, and the sections in the lower part of the casing can be equipped with nozzles for supply and discharge of liquid.

8. The horizontal packed heat and mass transfer apparatus according to claim 1, characterized in that at least one of the sections is equipped with a liquid heating element, and there is no vapor medium supply pipe.

9. The horizontal packed heat and mass transfer apparatus according to claim 1, characterized in that one or more sections are provided with an element for cooling the liquid.
